(19) United States
(12) Patent Application Publication
(10) Pub. No.: US 2012/0117919 A1
(43) Pub. Date: May 17, 2012

(54) METHOD OF STORING PHOTOCATALYTIC MEMBER

(75) Inventors: Kenichi Tokuhiro, Osaka (JP); Noboru Taniguchi, Osaka (JP); Tomohiro Kuroha, Osaka (JP); Shuzo Tokumitsu, Hyogo (JP); Yoshihiro Tsuji, Aichi (JP); Jun Inagaki, Aichi (JP); Masashi Nishiguchi, Aichi (JP)

(73) Assignee: PANASONIC CORPORATION, Kadoma-shi, Osaka (JP)

(21) Appl. No.: 12/672,813

(22) PCT Filed: Jun. 2, 2009
(86) PCT No.: PCT/JP2009/002470

§ 371 Date: Feb. 9, 2010

(30) Foreign Application Priority Data
Jun. 5, 2008 (JP) 2008-147749

(51) Int. Cl. B65B 55/00; B65B 29/00; B65B 31/02; C01G 23/047

(52) U.S. Cl. 53/400; 423/472; 53/396; 53/432

(57) ABSTRACT

A novel method for storing a photocatalytic member containing fluorine-containing anatase-type titanium oxide is provided, which is capable of suppressing the decrease in content of fluorine during storage in a photocatalytic member containing fluorine-containing anatase-type titanium oxide. The storage method of the present invention is a method for storing a photocatalytic member containing fluorine-containing anatase-type titanium oxide including storing the photocatalytic member in a surrounding environment with a relative humidity of 30% or less. According to the storage method of the present invention, for example, the elimination of fluorine from the surface of fluorine-containing titanium oxide can be suppressed, and the decrease in content of fluorine during storage in a photocatalytic member can be suppressed.

### TECHNICAL FIELD

The present invention relates to a method for storing a photocatalytic member containing fluorine-containing anatase-type titanium oxide.

### BACKGROUND ART

Recently, a photocatalytic material containing titanium oxide has been put into practical use in various situations for the purpose of sterilization, deodorization, antifouling, and the like. The photocatalytic material can be used not only in an outdoor place in which a light amount required for a catalytic reaction is likely to be ensured, but also in an indoor place, in which a light amount is unlikely to be ensured, by providing a light source in the vicinity of the photocatalytic material or the like.

In order to allow the catalytic reaction of a photocatalytic material to be expressed sufficiently, for example, in an indoor apparatus for the purpose of sterilization, deodorization, and the like, a light source (UV lamp) may be placed in the apparatus. However, when the activity of titanium oxide is low, the output of the light source needs to be enhanced, which increases an operating cost. Therefore, a photocatalytic material containing titanium oxide having high activity has been developed.

As a method for enhancing the activity of a photocatalytic material containing titanium oxide, it has been proposed that fluorine is contained in a photocatalytic material containing titanium oxide (for example, see Patent Documents 1-3).

### PRIOR ART DOCUMENTS

### Patent Documents

Patent Document 1: JP 2002-28494A

Patent Document 2: JP 2002-136878A

Patent Document 3: JP 2003-226554A

### DISCLOSURE OF INVENTION

### Problem to be Solved by the Invention

A photocatalytic member can recover the performance such as deodorization and air purification when irradiated with light. Although the photocatalytic member usually is packaged with a light-shielding material, it is packaged and stored without considering the air permeability of a package, the humidity in a package, and the like.

However, the inventors of the present invention found that, when a photocatalytic member containing fluorine-containing anatase-type titanium oxide is stored by an ordinary method, the content of fluorine in the fluorine-containing anatase-type titanium oxide may decrease.

The present invention provides a novel storage method capable of suppressing the decrease in the content of fluorine in fluorine-containing anatase-type titanium oxide during storage in a photocatalytic member containing fluorine-containing anatase-type titanium oxide.

### Means for Solving Problem

The present invention relates to a method for storing a photocatalytic member characterized in that a photocatalytic member containing fluorine-containing anatase-type titanium oxide is stored in a surrounding environment with a relative humidity of 30% or less.

### Effects of the Invention

According to a method for storing a photocatalytic member of the present invention, for example, the decrease in content of fluorine during storage can be suppressed by setting the relative humidity of the surrounding environment of a photocatalytic member during storage at 30% or less. Therefore, according to the storage method of the present invention, for example, the quality of a photocatalytic member containing fluorine-containing anatase-type titanium oxide during storage can be kept for a long period of time. Further, for example, the present invention preferably exhibits the effect of storing a photocatalytic member containing fluorine-containing titanium oxide in a state where the quality and the photocatalytic activity of a photocatalytic member can be kept for a long period of time.

### BRIEF DESCRIPTION OF DRAWINGS

FIG. 1 is a view showing a module for evaluating deodorization performance of a photocatalytic member used in one embodiment of a method for evaluating a photocatalytic member.

FIG. 2 is a graph showing a correlation between the content of fluorine in fluorine-containing titanium oxide and the deodorization rate coefficient in said embodiment.

FIG. 3 is a graph showing one example of temperature and humidity profiles of a photocatalytic member in a constant-temperature constant-humidity bath in an example of the present invention.

FIG. 4 is a graph showing one example of a change with time in content of fluorine in fluorine-containing titanium oxide during storage.

FIG. 5 is a graph showing another example of a change with time in content of fluorine in fluorine-containing titanium oxide during storage.

FIG. 6 is a graph showing still another example of a change with time in content of fluorine in fluorine-containing titanium oxide during storage.

### DESCRIPTION OF THE INVENTION

The present invention is based on the finding that the decrease in content of fluorine that may occur during storage can be suppressed by setting the relative humidity of the surrounding environment of a photocatalytic member containing fluorine-containing titanium oxide, which is to be stored, at 30% or less.

Specifically, the inventors of the present invention found that, when a photocatalytic member containing fluorine-containing titanium oxide is stored by an ordinary method, the content of fluorine in fluorine-containing titanium oxide may decrease, and the decrease in content of fluorine is influenced by the surrounding environment of the photocatalytic member, in particular, the humidity. The mechanism by which the content of fluorine decreases during storage is not clear. However, for example, it is assumed that an exchange reaction between fluorine chemical-bonded to titanium oxide and moisture contained in air is effected on the surface of fluorine-containing titanium oxide, and the exchange reaction is a reversible reaction that can be effected relatively easily, which decreases the content of fluorine. Thus, the mechanism by which the decrease in content of fluorine during storage is suppressed by the storage method of the present invention is assumed to be that the exchange reaction between fluorine and moisture in air is suppressed, for example, by setting the surrounding environment during storage at a predetermined relative humidity. It should be noted that the present invention is not limited to these mechanisms.

[Fluorine-Containing Anatase-Type Titanium Oxide]

The “fluorine-containing anatase-type titanium oxide” as used herein refers to anatase-type titanium oxide containing fluorine. As used herein, the “anatase-type titanium oxide” refers to titanium oxide whose diffraction peak appears in the vicinity of a diffraction angle 20 of 25.5 degrees in a powder X-ray diffraction spectrum measurement (electrode to be used: copper electrode). Unless otherwise specified herein, the “fluorine-containing titanium oxide” refers to “fluorine-containing anatase-type titanium oxide”, and the “titanium oxide” refers to “anatase-type titanium oxide”.

The content of fluorine in fluorine-containing titanium oxide is preferably 2.5% by weight or more, more preferably 2.5 to 4% by weight, and still more preferably 2.7 to 3.8% by weight in an element amount in terms of the photocatalytic activity. When the content of fluorine is 2.5% by weight or more, for example, fluorine having a large electronegativity is positioned on the surface of titanium oxide. Due to the electron-attracting function of fluorine, hydroxyl groups that are close to each other are activated, making it easy for hydroxyl radicals to be generated. This is considered to accelerate the photocatalytic reaction to enhance a deodorization rate. Further, when the content of fluorine is 4.0% by weight or less, preferably 3.8% by weight or less, for example, it is considered that the number of hydroxyl groups required for the photocatalytic reaction on the surface of titanium oxide can be maintained, which can maintain a deodorization rate. The “content of fluorine” as used herein refers to the amount (% by weight) of fluorine with respect to titanium contained in a photocatalytic member. The content of fluorine can be calculated by dissolving the entire photocatalytic member with an acid and obtaining the ratio (F⁻/Ti⁴⁺) between Ti⁴⁺ and F⁻, using inductively coupled high-frequency plasma spectrometry (ICP).

In fluorine-containing titanium oxide, the electron-attracting function of fluorine is expressed effectively and the acceleration function of a photocatalytic reaction is enhanced; therefore, it is preferred that fluorine and titanium oxide are chemical-bonded. Fluorine and titanium oxide being chemical-bonded includes, for example, titanium oxide and fluorine being bonded chemically, preferably, the state in which titanium oxide and fluorine are bonded at an atomic level instead of being supported or mixed, and more preferably the state in which titanium oxide and fluorine are bonded ionically. It is preferred that the above-mentioned chemical bond is an ionic bond, since fluorine and titanium oxide are bonded strongly, which further enhances the acceleration function of a photocatalytic reaction. Fluorine and titanium oxide being ionic-bonded refers to the case where, when fluorine-containing titanium oxide is analyzed by a photoelectron spectroscopy apparatus, a peak top of 1s orbit (F₁ₛ) of fluorine is in a range of 683 eV to 686 eV. This is derived from the following: the value of a peak top of titanium fluoride in which fluorine and titanium are ionic-bonded is in the above range.

In fluorine-containing titanium oxide, in terms of the acceleration of a photocatalytic reaction, fluorine chemical-bonded to titanium oxide is preferably 90% by weight or more, more preferably 95% by weight or more, and still more preferably 100% by weight in the entire fluorine in fluorine-containing titanium oxide, that is, the entire amount of fluorine contained in a titanium oxide photocatalyst is chemical-bonded. The content of fluorine that is chemical-bonded to titanium oxide is, for example, 2.35 to 3.6% by weight, preferably 2.5 to 3.5% by weight, and more preferably 2.5 to 3.3% by weight.

Since the photocatalytic activity can be enhanced, for example, the decomposition rate of an odorous component can be enhanced, it is preferred that the content of fluorine in fluorine-containing titanium oxide is 2.5 to 3.8% by weight, and 90% by weight of fluorine contained in fluorine-containing titanium oxide is bonded to titanium oxide.

As fluorine-containing titanium oxide, for example, a titanium oxide photocatalyst described in WO No. 2008/132824 can be used. Further, fluorine-containing titanium oxide may be used, which is obtained by a production method, for example, including the step of mixing an aqueous dispersion solution of anatase-type titanium oxide that adsorbs n-butylamine in an amount of 8 μmol/g or less with a fluorine compound, adjusting the pH of the mixed solution at 3 or less using an acid when the pH of the mixed solution exceeds 3, and allowing the titanium oxide to react with the fluorine compound in the mixed solution, and the step of washing a reactant obtained by the reaction. As the anatase-type titanium oxide that adsorbs n-butylamine in an amount of 8 μmol/g or less, for example, SSP-25 produced by Sakai Chemical Industry Co., Ltd. or the like can be used. As the water dispersion solution of the anatase-type titanium oxide, for example, CSB-M produced by Sakai Chemical Industry Co., Ltd. or the like can be used.

[Photocatalytic Member]

The “photocatalytic member” as used herein refers to a substance that shows photocatalytic activity when irradiated with light such as ultraviolet rays and a member containing the substance. Specifically, the substance refers to a substance capable of decomposing and eliminating various organic and inorganic compounds, performing sterilization, and the like, when irradiated with light, which preferably can be used for, for example, decomposing and eliminating odorous components such as acetaldehyde and mercaptans; sterilizing and eliminating fungi and algae; oxidatively decomposing and eliminating nitrogen oxides; and imparting an anti-fouling function by causing glass to have ultra-hydrophilic properties. Examples of the photocatalytic member include a powdery fluorine-containing titanium oxide photocatalyst, a dispersion solution of a fluorine-containing titanium oxide photocatalyst, a photocatalyst filter containing a substrate having air permeability and a photocatalytic layer with fluorine-containing titanium oxide supported by the substrate, and a photocatalyst sheet containing a substrate having no air permeability and a photocatalyst layer with fluorine-containing titanium oxide supported by the substrate. Examples of the substrate having air permeability include nonwoven fabrics, glass fibers, foamed metals, porous ceramics, and foamed resins. Examples of the substrate having no air permeability include glass, quartz, ceramics, and plastic substrates.

The photocatalytic member may contain components other than fluorine-containing titanium oxide. Examples of the other components include an adsorbent and a binder. Examples of the adsorbent include zeolite, activated carbon, silica, and apatite. Examples of the binder include inorganic binders such as tetraethoxysilane and colloidal silica. When the photocatalytic member is the above-mentioned photocatalyst filter, the content of fluorine-containing titanium oxide in a photocatalyst layer is, for example, 50% by weight or more, and preferably 60 to 100% by weight in terms of photocatalytic activity. Further, the content of the adsorbent in the photocatalyst layer is, for example, 50% by weight or less, preferably 0 to 40% by weight, and more preferably 10 to 40% by weight. The ratio between the fluorine-containing titanium oxide and the adsorbent in the photocatalytic member (fluorine-containing titanium oxide (content (% by weight)): adsorbent (content (% by weight))) is, for example, 100:0 to 50:50, and preferably 90:10 to 60:10 in terms of photocatalytic activity.

[Storage Method]

In one embodiment, the present invention relates to a method for storing a photocatalytic member containing fluorine-containing anatase-type titanium oxide, including storing the photocatalytic member in a surrounding environment with a relative humidity of 30% or less (hereinafter, also referred to as a “storage method of the present invention”). Herein, the “surrounding environment” refers to an environment around a photocatalytic member containing fluorine-containing titanium oxide, with which the photocatalytic member comes into contact. When the photocatalytic member is placed in a case, the “surrounding environment” refers to an environment (humidity·temperature) in the case, and the “surrounding environment with a relative humidity of 30% or less” refers to that the relative humidity in the case is 30% or less. The “relative humidity (%)” in the present invention is obtained by dividing the water vapor pressure of wet air by the saturated water vapor pressure at that temperature. Unless otherwise specified herein, the “humidity” refers to “relative humidity”.

The relative humidity and temperature in a surrounding environment can be measured by a thermohygrometer (main body: TRH-7x, sensor portion: THP-76 (produced by Shinyei Kaisha). Further, when a photocatalytic member is placed in an airtight case, a hole is made in the airtight case, and a thermohygrometer (main body: TRH-7x, sensor portion: THP-76 (Shinyei Kaisha)) is inserted in the airtight case through the hole, whereby a relative humidity and temperature can be measured.

According to the storage method of the present invention, as described above, the decrease in content of fluorine in fluorine-containing titanium oxide can be suppressed. Further, as described later, the following finding is obtained: the deodorization rate coefficient of a photocatalyst containing fluorine-containing titanium oxide has a substantially proportional relationship with the content of fluorine in fluorine-containing titanium oxide. Therefore, according to the storage method of the present invention, for example, the effect of keeping long-term reliability of quality of the photocatalytic member containing fluorine-containing titanium oxide is exhibited preferably.

According to the storage method of the present invention, the liberation ratio (%) of fluorine from fluorine-containing titanium oxide in the case where a photocatalytic member containing fluorine-containing titanium oxide is stored for 3 days can be set at 5% or less, for example. Further, according to the storage method of the present invention, the liberation ratio (%) of fluorine from fluorine-containing titanium oxide in the case where a photocatalytic member containing fluorine-containing titanium oxide is stored for 3 months can be set at, for example, 10% or less, preferably 5% or less. The liberation ratio can be calculated from the following expression.

Liberation ratio (%)={(F₀−F₁)/F₀}×100

In the above expression, F₀ represents the content of fluorine (% by weight) before the storage, and F₁ represents the content of fluorine (% by weight) after the storage for three days. A method for measuring the content of fluorine is as described above.

The storage method of the present invention is suitable for, for example, storing a photocatalytic member containing fluorine-containing titanium oxide in a place where the relative humidity of outside air exceeds (or can exceed) 30% easily or in an indoor place (e.g., a warehouse, a container) where outside air can circulate and the relative humidity of outside air exceeds (or can exceed) 30% easily, and/or storing such a photocatalytic member during transportation. Examples of the places where the relative humidity of outside air exceeds (or can exceed) 30% easily include the sea, the river, the lake, a tropical climate region, a temperate climate region, and a rainy climate region.

The surrounding environment of the photocatalytic member has a relative humidity of 30% or less, preferably 20% or less, and more preferably 10% or less, in terms of suppressing the decrease in content of fluorine. The relative humidity of the surrounding environment preferably is as low as possible. Although the lower limit of the relative humidity is not particularly limited, it is, for example, 0% or more. The temperature in the surrounding environment is not particularly limited, and for example, 5° C. to 90° C., preferably 15° C. to 70° C. The storage method of the present invention includes setting the temperature of the surrounding environment at 5° C. to 90° C., preferably 15° C. to 70° C.

The storage method of the present invention may include, for example, setting the relative humidity of the surrounding environment of a photocatalytic member containing fluorine-containing titanium oxide, which is to be stored, at 30% or less.

Examples of the method for setting the relative humidity of the surrounding environment of a photocatalytic member during storage at a predetermined value include storing the photocatalytic member in an airtight case, storing the photocatalytic member in a vacuum case, and storing the photocatalytic member in an atmosphere in which dry air or inert gas is allowed to circulate. Therefore, the storage method of the present invention includes, for example, storing the photocatalytic member in an airtight case, storing the photocatalytic member in a vacuum case, and storing the photocatalytic member in an atmosphere in which dry air or inert gas is allowed to circulate.

The airtight case may be a case having airtightness that does not allow air in the case to flow out. The shape of the case is not particularly limited, and for example, may have a bag shape or a box shape. Examples of the material for the airtight case include resins such as polyethylene, polyethyleneterephthalate, vinyl chloride, polystyrene, polypropylene, polycarbonate, acrylic resin, and polyamide, and metals such as aluminum and iron.

The airtight case may contain a hygroscopic substance since the relative humidity in the case (surrounding environment of a photocatalytic member) can be set at 30% or less easily. Examples of the hygroscopic substance include silica gel, zeolite, molecular sieve, calcium chloride, calcium oxide, phosphorus pentoxide, granular soda lime, and magnesium perchlorate. The hygroscopic substance has, for example, a hygroscopic degree of preferably 55% or less, more preferably 10% to 55%. The hygroscopic degree of the hygroscopic substance can be calculated, for example, using the following expression. W₀ (g) in the following expression represents a weight (g) of a hygroscopic substance obtained by storing 100 g of an unused hygroscopic substance at 25° C. under an atmosphere of 60% RH for one hour, and W₁(g) represents a weight (g) of a hygroscopic substance obtained by storing 100 g of an unused hygroscopic substance at 40° C. under an atmosphere of 90% RH for one day and further storing the substance at 25° C. under an atmosphere of 60% RH for one hour.

Hygroscopic degree (%)={(W₁−W₀)/W₀}×100

The airtight case may be filled with inert gas since the relative humidity in the case can be adjusted easily. Examples of the inert gas include nitrogen gas, argon gas, neon gas, and helium gas, and nitrogen gas and argon gas are preferred.

The vacuum case may be, for example, the one in which a vacuum state can be obtained. The vacuum state can be obtained, for example, by sealing under a reduced pressure. The material for the case is not particularly limited, and examples thereof include resins such as polyethylene, polyethyleneterephthalate, vinyl chloride, polystyrene, polypropylene, polycarbonate, acrylic resin, and polyamide; aluminum and Teflon (registered trademark). The dry air is, for example, air with a relative humidity of 10% or less and preferably 5% or less.

In another embodiment, the storage method of the present invention may be a storage method at a time of transportation of a photocatalytic member containing fluorine-containing titanium oxide. Therefore, in another embodiment, the present invention may include a method for transporting a photocatalytic member containing fluorine-containing titanium oxide, including transporting a photocatalytic member containing fluorine-containing titanium oxide while storing the photocatalytic member containing fluorine-containing titanium oxide in a surrounding environment with a relative humidity of 30% or less.

[Transportation Method]

Thus, in still another embodiment, the present invention relates to a method for transporting a photocatalytic member containing fluorine-containing anatase-type titanium oxide, including transporting the photocatalytic member sealed in an airtight case (hereinafter, also referred to as the “transportation method of the present invention”). According to the transportation method of the present invention, for example, even when a photocatalytic member containing fluorine-containing titanium oxide is stored in a strict atmosphere (for example, temperature: 60° C., relative humidity: 90%) such as that in a transportation container on the sea, the effect of suppressing the decrease in content of fluorine in fluorine-containing titanium oxide is exhibited preferably. In the transportation method of the present invention, “transporting the photocatalytic member sealed in an airtight case” may include transporting a photocatalytic member containing fluorine-containing titanium oxide while sealing it in an airtight case. The relative humidity in the airtight case under the condition that the photocatalytic member is sealed in an airtight case is, for example, 30% or less, preferably 20% or less, and more preferably 10% or less.

The transportation may include transporting an airtight case, in which the photocatalytic member is sealed, placed in a container. Examples of the transportation in the present invention include transportation by a track, a ferry, an airplane, or the like.

For example, a hygroscopic substance may be sealed in the airtight case. Further, the airtight case may be filled with inert gas and/or dry air. In the transportation method of the present invention, fluorine-containing titanium oxide, a photocatalytic member, a hygroscopic substance, an airtight case, inert gas, and dry air are as described above.

In another embodiment, the transportation method of the present invention may be a method for transporting a photocatalytic member including storing a fluorine-containing titanium oxide photocatalytic member by the storage method of the present invention during transportation.

[Production Method]

In still another embodiment, the present invention relates to a method for producing a photocatalytic member product containing fluorine-containing anatase-type titanium oxide, including the step of sealing a photocatalytic member containing fluorine-containing anatase-type titanium oxide in an airtight case. According to the method for producing a photocatalytic member product of the present invention, for example, the effect of providing a photocatalytic member product capable of suppressing the decrease in content of fluorine in fluorine-containing titanium oxide in storage and/or transportation of a photocatalytic member containing fluorine-containing titanium oxide is exhibited preferably.

The photocatalytic member is sealed in the airtight case preferably under a condition of a relative humidity of 30% or less, more preferably under conditions of a relative humidity of 30% or less and a temperature of 50° C. or less, still more preferably under conditions of a relative humidity of 20% or less and a temperature of 25° C. or less, and further preferably under conditions of a relative humidity of 10% or less and a temperature of 25° C. or less. In the sealing step, the photocatalytic member may be sealed in the airtight case, for example, together with a hygroscopic substance. Further, the airtight case may be filled with inert gas and/or dry air.

The production method of the present invention may include the step of coating a substrate with a photocatalytic material containing fluorine-containing titanium oxide. The coating of the substrate may be performed by dispersing the photocatalytic material in a solvent such as water and ethyl alcohol and coating the substrate with the dispersion solution. As the substrate, for example, the above-mentioned substrate with air permeability, the above-mentioned substrate without air permeability, or the like can be used. The photocatalytic material further may contain an adsorbent, a binder, and the like.

In the production method of the present invention, fluorine-containing titanium oxide, a photocatalytic member, a hygroscopic substance, an airtight case, inert gas, an adsorbent, a binder, and dry air are as described above.

Hereinafter, the relationship between the function of the photocatalytic member containing fluorine-containing titanium oxide and the content of fluorine in fluorine-containing titanium oxide will be described with reference to the drawings.

### One Embodiment of a Method for Evaluating a Photocatalytic Member

<Module for Evaluating Deodorization Performance of a Photocatalytic Member 3>

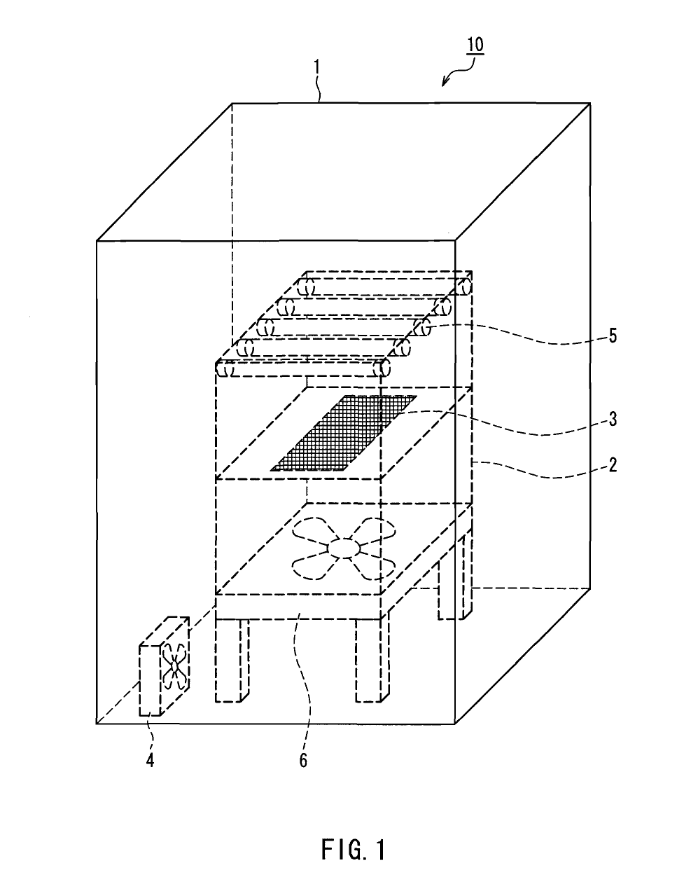

FIG. 1 is a view showing one example of a module for evaluating the deodorization performance of the photocatalytic member 3. The evaluation of activity of the photocatalytic member 3 in the present embodiment is performed by measuring the deodorization performance of acetaldehyde, using the above module.

As shown in FIG. 1, the module for evaluating deodorization performance of the photocatalytic member 3 is composed of a box 1 (acrylic box, inner capacity: 100 L), a measurement device housing 2, a stirring fan 4, and a black light blue fluorescent lamp 5.

The measurement device housing 2 and the stirring fan 4 are set in the box 1, and the photocatalytic member 3 (60 mm×60 mm) is inserted in the measurement device housing 2. Further, a fan 6 is provided below the measurement device housing 2 so that gas in the box 1 passes through the photocatalytic member 3. Five black light blue fluorescent lamps 5 (6 W, produced by Panasonic Corporation) are set at an interval of about 50 mm above the photocatalytic member 3, and the distance to the photocatalytic member 3 previously is adjusted so that the intensity of light during irradiation with a probe (UVS365, produced by Ushio Inc.) becomes 1.0 mW/cm².

<Experiment for Evaluating Deodorization Performance of the Photocatalytic Member 3>

An experiment for measuring deodorization performance by the photocatalytic member 3 is performed by the following method.

The stirring fan 4 is rotated for about 30 minutes while dry air with a relative humidity of 5% or less is introduced into the box 1, whereby the inside of the box 1 is replaced by the dry air. After that, 1.80 L of 524 ppm reference gas of acetaldehyde diluted with nitrogen is introduced into the box 1 so that the concentration of acetaldehyde in the box 1 becomes about 10 ppm. Immediately after acetaldehyde is introduced into the box 1, the stirring fan 4 is stopped.

Almost simultaneously with the suspension of the stirring fan 4, the black light blue fluorescent lamps 5 are lit and the fan 6 in the measurement device housing 2 is rotated. After the fan 6 is rotated, gas chromatography (GC-14B, produced by Shimazu Corporation) having an every-three-minute automatic sampling device is started. The sampling is performed at one sampling per three minutes continuously for one hour. In gas chromatography, Gaskuropack 56 (produced by GL Sciences Inc.) is used as a column.

In the evaluation method, the deodorization ability of the photocatalytic member 3 is evaluated to be more excellent as a deodorization rate coefficient is larger. Herein, the “deodorization rate coefficient” is defined as a value obtained by performing log approximation of a change with time of an acetaldehyde concentration and taking an absolute value of a gradient thereof. The deodorization rate coefficient is calculated, using an acetaldehyde concentration, while discriminating adsorption deodorization ability by an adsorbent from decomposition deodorization ability by the photocatalytic member 3. In the evaluation method, in order to evaluate the decomposition deodorization ability by the photocatalytic member 3 exactly, the concentration of acetaldehyde from 3 minutes after the start to 15 minutes after the start was used instead of the concentration of acetaldehyde from the start to 3 minutes after the start.

<Method for Measuring the Content of Fluorine of Fluorine-Containing Titanium Oxide>

The fluorine content of fluorine-containing titanium oxide in the photocatalytic member 3 is measured by the following method.

Tungsten trioxide (60 mg) is added as a combustion improver to the weighed photocatalytic member 3 (about 5 to 8 mg) and is heated to 1,080° C. in an automatic sample combustion device (AQF-100, produced by Dia Instrument Co., Ltd.), using argon (200 ml/min.) and oxygen (400 ml/min.) as combustion gas. The gas thus generated is absorbed by an absorbing solution formed of a mixed aqueous solution of hydrogen peroxide solution (900 mg/L,) and sodium carbide (3 mM), and the concentration of fluoride ion in the absorbing solution is measured by ion chromatography (ICS-1500, produced by Dionex Corporation).

According to the ion chromatography, conductivity is detected using an eluent formed of a mixed solution of sodium carbonate (2.7 mM) and sodium hydrogen carbonate (0.3 mM), and Guard column AG12A and Separation column AS12A (produced by Dionex Corporation), whereby the concentration of fluoride ions is measured.

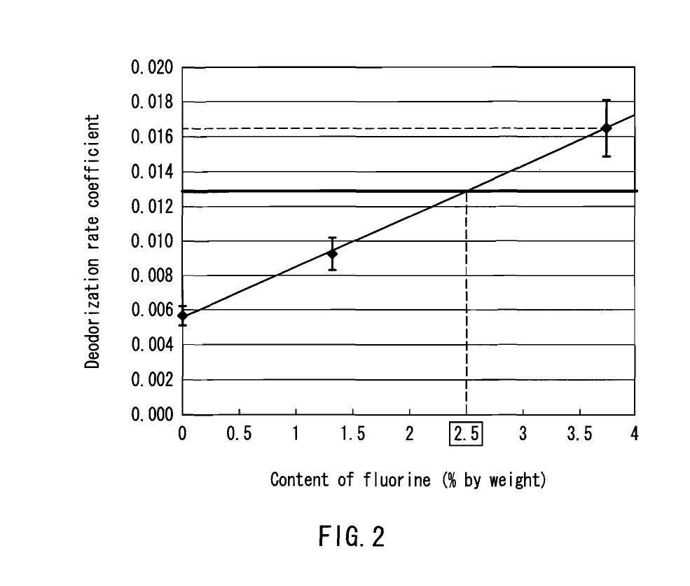

FIG. 2 shows an exemplary graph showing a correlation between the content of fluorine and the deodorization rate coefficient of fluorine-containing titanium oxide according to the evaluation method. FIG. 2 shows results of examples using the photocatalytic members 3 containing fluorine-containing titanium oxide containing 0% by weight of fluorine, 1.3% by weight of fluorine, and 3.76% by weight of fluorine, respectively.

As shown in FIG. 2, the content of fluorine and the deodorization rate coefficient have a substantially proportional relationship. Therefore, the decrease in content of fluorine is not preferred, since it means the decrease in deodorization rate coefficient of a photocatalytic member. For example, the photocatalytic member 3 containing fluorine-containing titanium oxide containing 3.76% by weight of fluorine exhibits a deodorization rate coefficient of a high numerical value, i.e., 0.0163. When it is assumed that the deodorization rate acceptable generally is 0.013 corresponding to 80% of the deodorization rate coefficient, as is apparent from FIG. 2, the content of fluorine of fluorine-containing titanium oxide desirably is 2.5% by weight or more.

### EXAMPLES

Hereinafter, examples will be described. Unless otherwise specified in the following examples, the term “humidity” means “relative humidity”.

### Example A

In Example A, as a photocatalytic member, a photocatalytic member containing fluorine-containing anatase-type titanium oxide containing 3.76% by weight of fluorine with respect to titanium oxide was used. The photocatalytic member was stored in a constant-temperature bath (DN43, Yamato Scientific Co., Ltd.) set at predetermined temperature and humidity shown in Examples 1, 2 and Comparative Example 1 or a constant-temperature constant-humidity bath (PL-2KP, Espec Corporation) for 72 hours. Then, the content of fluorine of each fluorine-containing titanium oxide was measured. Table 1 shows storage conditions (relative humidity, temperature) in Examples 1, 2 and Comparative Example 1. The content of fluorine was calculated by dissolving a photocatalytic member (fluorine-containing titanium oxide) with an acid and obtaining a ratio (F⁻/Ti⁴⁺) between Ti⁴⁺ and F⁻ in a solution, using inductively coupled high-frequency plasma spectrometry (ICP).

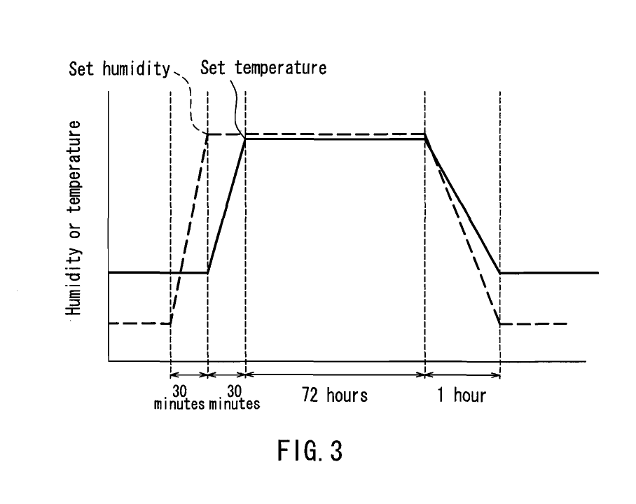

FIG. 3 shows temperature and humidity profiles of the photocatalytic member in the constant-temperature constant-humidity bath in Example A. As shown in FIG. 3, the storage start time in Example A was set immediately after (one hour after) the photocatalytic member reached predetermined set temperature and set humidity.

In Example 1, the photocatalytic member was stored in a constant-temperature bath under the conditions of a relative humidity of 10% and a temperature of 25° C., 40° C., or 60° C. for 72 hours, respectively. In Example 1, the temperature of the constant-temperature bath was set at the above predetermined temperature, and air containing moisture was allowed to circulate in the constant-temperature bath so that the humidity became about 10%.

In Example 2, the photocatalytic member was stored in a constant-temperature constant-humidity bath set at a relative humidity of 30% and a temperature of 25° C., 40° C., or 60° C. for 72 hours, respectively.

In Comparative Example 1, the photocatalytic member was stored in a constant-temperature constant-humidity bath set at a relative humidity of 50%, a temperature of 25° C., 40° C., or 60° C. for 72 hours, respectively.

<Evaluation>

The following Table 1 shows the ratio of the content of fluorine in fluorine-containing titanium oxide after a constant-temperature and constant-humidity experiment in Examples 1, 2 and Comparative Example 1 when 3.76% by weight of the content of fluorine before the constant-temperature and constant-humidity experiment was assumed to be 100, and determination results thereof. In the determination method in Example A, in the case where the ratio of the content of fluorine after the constant-temperature and constant-humidity experiment was 95 to 100, the content of fluorine is considered not to have changed, and this case was determined to be “Satisfactory”. On the other hand, in the case where the ratio of the content of fluorine after the constant-temperature and constant-humidity experiment was less than 95, the content of fluorine was considered to have decreased and determined to be “Unsatisfactory”. The ratio of the content of fluorine after the constant-temperature and constant-humidity experiment was calculated by the following Expression.

Ratio of content of fluorine after constant-temperature and constant-humidity experiment={(Content of fluorine after constant-temperature and constant-humidity experiment (% by weight)/(content of fluorine before constant-temperature and constant-humidity experiment (% by weight)))×100

TABLE 1

| | | Temperature 25° C. | | Temperature 40° C. | | Temperature 60° C. | |
|---|---|---|---|---|---|---|---|
| | | Ratio of content | | Ratio of content | | Ratio of content | |
| | Relative | of fluorine | | of fluorine | | of fluorine | |
| | humidity | after experiment | Determination | after experiment | Determination | after experiment | Determination |
| Ex. 1 | 10% | 100 | Satisfactory | 100 | Satisfactory | 100 | Satisfactory |
| Ex. 2 | 30% | 100 | Satisfactory | 99 | Satisfactory | 95 | Satisfactory |
| Comp. | 50% | 100 | Satisfactory | 98 | Satisfactory | 90 | Unsatisfactory |
| Ex. 1 | | | | | | | |

As shown in Table 1, in Examples 1 and 2, the determination was “Satisfactory” at all the temperatures. That is, in Examples 1 and 2, all the liberation ratios of the content of fluorine during storage were 5% or less. Particularly, in Example 1, more preferred results were obtained without any decrease in content of fluorine at all the temperatures. On the other hand, in Comparative Example 1, the content of fluorine decreased by 10% at a temperature of 60° C., and the determination was “Unsatisfactory”.

In Comparative Example 1a, a photocatalytic member was stored under the same conditions as those in Comparative Example 1, except that fluorine-containing titanium oxide containing 3.65% by weight of fluorine was used as a photocatalytic member and the temperature of the constant-temperature bath or constant-temperature constant-humidity bath was set at 25° C. Table 2 shows the results.

TABLE 2
Comparative Example 1a

| | |
|---|---|
| Number of | Temperature 25° C. Relative humidity 50% |

| storage days | Content of fluorine | Ratio of content of fluorine |
|---|---|---|
| (days) | (wt %) | (%) |
| 0 | 3.65 | 100 |
| 7 | 3.62 | 99.2 |
| 8 | 3.58 | 98.1 |
| 10 | 3.57 | 97.8 |
| 14 | 3.5 | 95.9 |
| 21 | 3.43 | 94 |
| 28 | 3.35 | 91.8 |

As shown in Table 2, in Comparative Example 1a in which the relative humidity was 50%, when the photocatalytic member was stored for 21 days or more, the content of fluorine decreased by 6% or more, compared with the content of fluorine before storage.

In Comparative Example 1b, a photocatalytic member was stored under the same conditions as those in Comparative Example 1, except that fluorine-containing titanium oxide containing 3.65% by weight of fluorine was used as a photocatalytic member, and the temperature of the constant-temperature bath or constant-temperature constant-humidity bath was set at 40° C. Table 3 shows the results.

TABLE 3
Comparative Example 1b

| | |
|---|---|
| Number of | Temperature 40° C. Relative humidity 50% |

| storage days | Content of fluorine | Ratio of content of fluorine |
|---|---|---|
| (days) | (wt %) | (%) |
| 0 | 3.65 | 100 |
| 5 | 3.29 | 90.1 |

As shown in Table 3, under the above conditions that the relative humidity was 50%, when the photocatalytic member was stored for 5 days or more, the content of fluorine decreased by 6% or more, compared with the content of fluorine before storage.

### Example B

In Example B, a change with time of the content of fluorine of fluorine-containing titanium oxide was measured, when 3 g of a photocatalytic member weighed in a powdery state was stored for 3 months in a constant-temperature constant-humidity bath (PL-2KP, produced by Espec Corporation) set at a temperature of 40° C. and a humidity of 50% under the conditions of Examples 3-9 and Comparative Examples 2-4 shown below. The following Table 4 shows the storage conditions in Examples 3-9 and Comparative Examples 2-4. As the photocatalytic member, a photocatalytic member containing fluorine-containing titanium oxide containing 3.76% by weight of fluorine was used.

In Example 3, a photocatalytic member was placed in an airtight case with a chuck made of polyethylene (170×240 mm) together with silica gel (250 g, produced by Kanto Chemical Co., Ltd.) that was a hygroscopic substance, and stored in a constant-temperature constant-humidity bath in a sealed state for 3 months. As the silica gel, silica gel dried at 180° C. for 2 hours before the experiment was used. The case was sealed at room temperature.

In Example 4, only a photocatalytic member was placed in an airtight case with a chuck made of polyethylene (170×240 mm), and stored in a constant-temperature constant-humidity bath in a sealed state for 3 months. The case was sealed under the same conditions as those in Example 3.

In Comparative Example 2, a photocatalytic member was placed in a Petri dish, and stored in a constant-temperature constant-humidity bath without being sealed particularly for 3 months.

In Example 5, a photocatalytic member was placed in an aluminum case, deaerated with a vacuum pump, and stored in a constant-temperature constant-humidity bath in a sealed state for 3 months.

In Comparative Example 3, a photocatalytic member was placed in a Petri dish and stored in a constant-temperature constant-humidity bath without being sealed particularly for 3 months.

In Example 6, a photocatalytic member was placed in an aluminum case, the case was filled with nitrogen gas with a humidity at 25° C. of 10% or less, and the photocatalytic member was stored in a constant-temperature constant-humidity bath in a sealed state for 3 months.

In Example 7, a photocatalytic member was placed in an aluminum case, the case was filled with argon gas with a humidity at 25° C. of 10% or less, and the photocatalytic member was stored in a constant-temperature constant-humidity bath in a sealed state for 3 months.

In Example 8, a photocatalytic member was placed in a two-port aluminum case, and stored in a constant-temperature constant-humidity bath for 3 months while nitrogen gas with a humidity at 25° C. of 10% or less was allowed to circulate.

In Example 9, a photocatalytic member was placed in a two-port aluminum case, and stored in a constant-temperature constant-humidity bath for 3 months while argon gas with a humidity at 25° C. of 10% or less was allowed to circulate.

In Comparative Example 4, a photocatalytic member was placed in a Petri dish, and stored in a constant-temperature constant-humidity bath without being sealed particularly for 3 months.

<Evaluation>

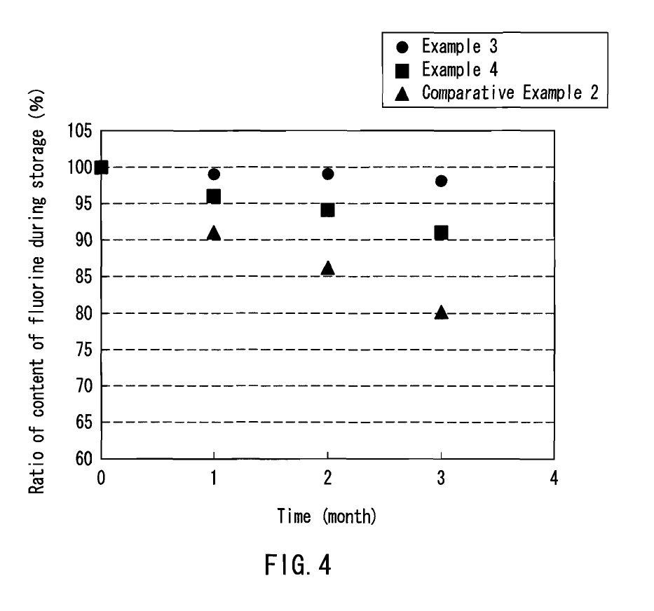

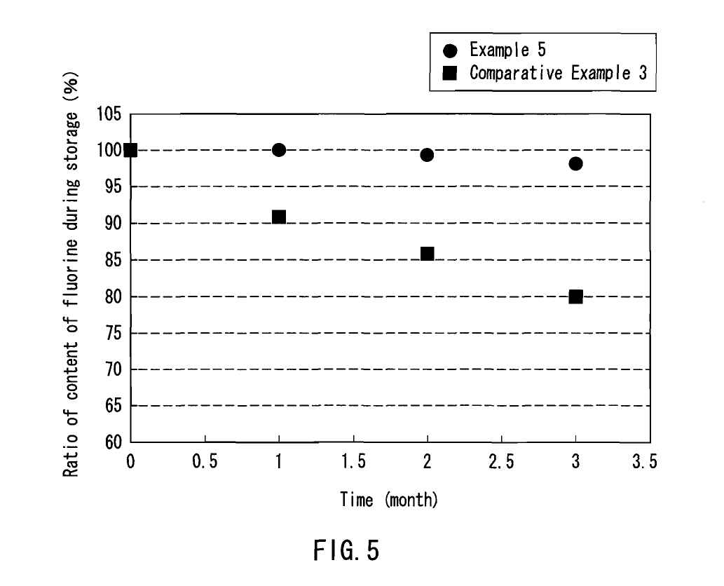

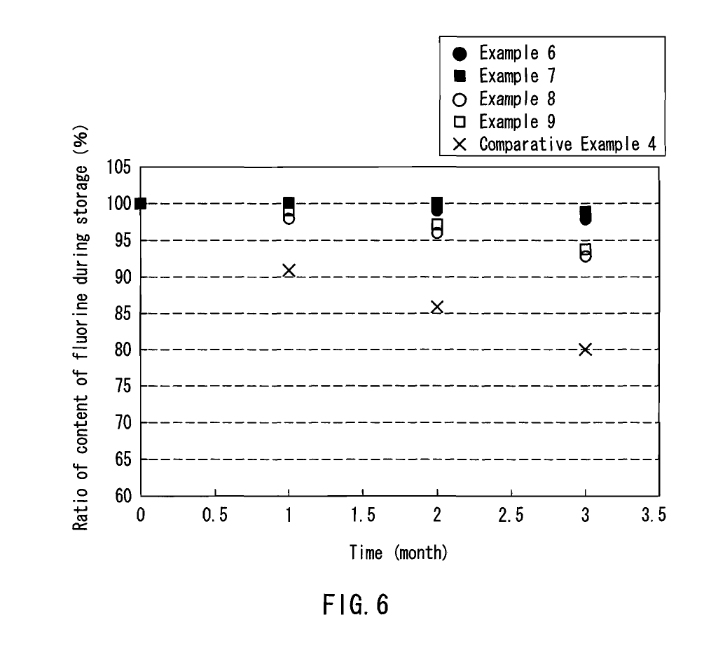

The evaluation was performed based on the ratio of the content of fluorine of fluorine-containing titanium oxide during storage when 3.76% by weight of the content of fluorine before the experiment was assumed to be 100. The following Table 4 and FIGS. 4-6 show the obtained results. FIG. 4 is a graph showing a change with time in a content of fluorine of fluorine-containing titanium oxide in Examples 3, 4 and Comparative Example 2. FIG. 5 is a graph showing a change with time in a content of fluorine of fluorine-containing titanium oxide in Example 5 and Comparative Example 3. FIG. 6 is a graph showing a change with time in content of fluorine of fluorine-containing titanium oxide in Examples 6-9 and Comparative Example 4.

TABLE 4

| | | Ex. 3 | Ex. 4 | Com. Ex. 2 | Ex. 5 | Com. Ex. 3 | Ex. 6 |
|---|---|---|---|---|---|---|---|
| Storage | | Airtight | Airtight | Petri dish | Vacuum | Petri dish | Airtight |
| condition | | case | case | (without being | case | (without being | case |
| | | (PE) | (PE) | sealed airtightly) | (aluminum) | sealed airtightly) | (aluminum) |
| | | Silica gel | — | — | Vacuum | — | N₂ gas |
| | Relative | 20% | 30% | 50% | 0% | 50% | 10% or less |
| | humidity | | | | | | |
| Ratio of | Before | 100 | 100 | 100 | 100 | 100 | 100 |
| content of | storage | | | | | | |
| fluorine | After one | 99 | 96 | 91 | 100 | 91 | 100 |
| during | month | | | | | | |
| storage | After two | 99 | 94 | 86 | 99 | 86 | 99 |
| (%) | months | | | | | | |
| | After three | 98 | 91 | 80 | 98 | 80 | 98 |
| | months | | | | | | |

| | | Ex. 7 | Ex. 8 | Ex. 9 | Com. Ex. 4 |
|---|---|---|---|---|---|
| Storage | | Airtight | Two-port case | Two-port case | Petri dish |
| condition | | case | (aluminum) | (aluminum) | (without being |
| | | (aluminum) | (without being | (without being | sealed airtightly) |
| | | | sealed airtightly) | sealed airtightly) | |
| | | Ar gas | N₂ gas | Ar gas | — |
| | Relative | 10% or less | 10% or less | 10% or less | 50% |
| | humidity | | | | |
| Ratio of | Before | 100 | 100 | 100 | 100 |
| content of | storage | | | | |
| fluorine | After one | 100 | 98 | 99 | 91 |
| during | month | | | | |
| storage | After two | 100 | 96 | 97 | 86 |
| (%) | months | | | | |
| | After three | 99 | 93 | 94 | 80 |
| | months | | | | |

As shown in the above Table 4 and FIG. 4, in Examples 3 and 4, the content of fluorine in titanium oxide after three months was about 90% or more of the content of fluorine before the experiment, revealing that the decrease rate of the content of fluorine was suppressed. Particularly, in Example 3, even after three months elapsed, the content of fluorine hardly decreased, which showed a more preferred result. On the other hand, in Comparative Example 2, the content of fluorine in fluorine-containing titanium oxide after three months decreased to about 80% of the content of fluorine before the experiment.

As shown in the above Table 4 and FIG. 5, in Example 5, the content of fluorine in fluorine-containing titanium oxide after three months was about 98% of the content of fluorine before the experiment, revealing that the decrease rate of the content of fluorine was suppressed. On the other hand, in Comparative Example 3, the content of fluorine after three months decreased to 80% of the content of fluorine before the experiment.

As shown in the above Table 4 and FIG. 6, in Examples 6-9, the content of fluorine after three months was about 93% or more of the content of fluorine before the experiment, revealing that the decrease rate of the content of fluorine was suppressed. In particular, in Examples 6 and 7, the content of fluorine after three months was about 98% of the content of fluorine before the experiment; that is, the content of fluorine hardly decreased, which showed a more preferred result. Further, as shown in Examples 6-9, there was substantially no difference between nitrogen gas and argon gas. On the other hand, in Comparative Example 4, the content of fluorine after three months decreased to 80% of the content of fluorine before the experiment.

In the above Examples 3 and 4, the material for the airtight case is not limited to polyethylene, and may be polyethyleneterephthalate, vinyl chloride, polystyrene, polypropylene, polycarbonate, acrylic resin, polyamide, or the like, or metal such as aluminum or iron.

Further, the hygroscopic substance is not limited to silica gel, and may be zeolite, molecular sieve, or the like.

Although the aluminum case is used in Example 5, another metal such as iron, or plastic processed so as not to pass moisture or the like may be used.

In Examples 6-9, the gas that is to fill the airtight case or to circulate therein is not limited to nitrogen gas or argon gas, and neon gas, helium gas, or the like may be used.

### INDUSTRIAL APPLICABILITY

A method for storing a photocatalytic member in the present invention is useful as a method for storing a photocatalytic member containing titanium oxide containing fluorine, used for the purpose of deodorization, odor elimination, air cleaning, or the like.

### DESCRIPTION OF REFERENCE NUMERALS

1 box

2 measurement device housing

3 photocatalytic member

4 stirring fan

5 black light blue fluorescent lamp

6 fan

1. A method for storing a photocatalytic member containing fluorine-containing anatase-type titanium oxide,
wherein the photocatalytic member is stored in a surrounding environment with a relative humidity of 30% or less.

2. The method for storing a photocatalytic member according to claim 1, wherein the relative humidity is 10% or less.

3. The method for storing a photocatalytic member according to claim 1, wherein the storage of the photocatalytic member includes storing the photocatalytic member in an airtight case.

4. The method for storing a photocatalytic member according to claim 3, wherein the airtight case contains a hygroscopic substance.

5. The method for storing a photocatalytic member according to claim 4, wherein the hygroscopic substance is silica gel.

6. The method for storing a photocatalytic member according to claim 3, wherein the airtight case is filled with inert gas.

7. The method for storing a photocatalytic member according to claim 6, wherein the inert gas is nitrogen and/or argon.

8. The method for storing a photocatalytic member according to claim 1, wherein the storage of the photocatalytic member includes storing the photocatalytic member in a vacuum case.

9. The method for storing a photocatalytic member according to claim 1, wherein the storage of the photocatalytic member includes storing the photocatalytic member in an atmosphere in which dry air or inert gas is allowed to circulate.

10. The method for storing a photocatalytic member according to claim 1, wherein a content of fluorine in the fluorine-containing titanium oxide is 2.5% by weight or more.

11-13. (canceled)
